(19) United States
(12) Patent Application Publication
(10) Pub. No.: US 2026/0361405 A1
(43) Pub. Date: Nov. 12, 2026

(54) FIXED STATION, MOVING BODY, COMMUNICATION SYSTEM AND BEAM DIRECTION CONTROL METHOD

(71) Applicant: NTT, Inc., Tokyo (JP)

(72) Inventors: Naotaka SHIBATA, Musashino-shi (JP); Takeshi IMAI, Musashino-shi (JP); Shin KANEKO, Musashino-shi (JP); Ritsuki HAMAGAMI, Musashino-shi (JP)

(73) Assignee: NTT, Inc., Tokyo (JP)

(21) Appl. No.: 19/121,613

(22) PCT Filed: Oct. 27, 2022
(86) PCT No.: PCT/JP2022/040143

§ 371 Date: Apr. 16, 2025

(51) Int. Cl. H04B 10/112

(52) U.S. Cl. CPC H04B 10/112

(57) ABSTRACT

A fixed station performs free space optical communication with a mobile object in which a moving path is not determined in advance, and includes a movement control information reception unit that receives movement control information, which is information for moving the mobile object to a designated position, the movement control information being transmitted from a mobile object control terminal that controls an operation of the mobile object, an adjustment amount calculation unit that calculates an adjustment amount for controlling an irradiation direction of a beam at every control cycle by predicting a speed change of the mobile object based on the movement control information received by the movement control information reception unit, and a direction control unit that controls the irradiation direction of the beam at every control cycle based on the adjustment amount at every control cycle which is calculated by the adjustment amount calculation unit.

### TECHNICAL FIELD

The present invention relates to a fixed station, a mobile object, a communication system, and a beam direction control method.

### BACKGROUND ART

In the related art, a technique related to free space optical communication (FSO) has been proposed (see, for example, NPL 1). Free space optical communication is a technique for emitting a laser beam into a space to perform communication. Free space optical communication can be utilized not only between fixed stations but also between a fixed station and a mobile object. In the technique disclosed in NPL 1, free space optical communication is performed between a train as a mobile object and a land station as a fixed station.

FIG. 8 is a diagram showing a configuration example of a communication system 1000 of the related art. The communication system 1000 includes a fixed station 150, a mobile object 250, and a mobile object control terminal 350. The fixed station 150 performs free space optical communication with the mobile object 250 by controlling a beam irradiation direction. The mobile object 250 is, for example, a train, and performs free space optical communication with the fixed station 150 by controlling the beam irradiation direction. The mobile object 250 moves in response to an instruction given from the mobile object control terminal 350. When the mobile object 250 is a train, the mobile object control terminal 350 is provided in the train. The mobile object control terminal 350 operates the mobile object 250 by transmitting movement control information including a movement instruction to the mobile object 250.

The fixed station 150 includes a data processing unit 101, an optical signal transmission unit 102, an optical signal reception unit 103, a data acquisition unit 104, a transmission/reception coupling unit 105, a distribution unit 106, a direction control mechanism 107, an optical signal center deviation detection unit 108, a direction adjustment amount calculation unit 109, and a direction control unit 110. The mobile object 250 includes a data processing unit 201, an optical signal transmission unit 202, an optical signal reception unit 203, a data acquisition unit 204, a transmission/reception coupling unit 205, a distribution unit 206, a direction control mechanism 207, an optical signal center deviation detection unit 208, a direction adjustment amount calculation unit 209, a direction control unit 210, a movement control information reception unit 211, and a mobile object control unit 212.

The data processing unit 101 performs framing and signal processing on data to be transmitted to a mobile object 200. The optical signal transmission unit 102 converts an output signal of the data processing unit 101 into an optical signal. The optical signal reception unit 103 receives an optical signal transmitted from the mobile object 250 and converts the received optical signal into an electrical signal. The data acquisition unit 104 performs signal processing such as demodulation and decoding and deframing on the output of the optical signal reception unit 103. The transmission/reception coupling unit 105 outputs the optical signal output from the optical signal transmission unit 102 and the optical signal input via the direction control mechanism 107 in a desired direction. For example, the transmission/reception coupling unit 105 outputs the optical signal output from the optical signal transmission unit 102 to the direction control mechanism 107. For example, the transmission/reception coupling unit 105 outputs the optical signal input via the direction control mechanism 107 to the distribution unit 106.

The distribution unit 106 distributes and outputs the optical signal output from the transmission/reception coupling unit 105 to the optical signal reception unit 103 and the optical signal center deviation detection unit 108. The direction control mechanism 107 adjusts a direction for performing free space optical communication with the mobile object 250. For example, the direction control mechanism 107 adjusts the direction of a laser so that the directivity is directed in a direction in which an optical signal can be transmitted and received to and from the mobile object 250. The optical signal center deviation detection unit 108 detects a deviation between a reception surface and an optical signal based on the optical signal distributed by the distribution unit 106.

The direction adjustment amount calculation unit 109 calculates an adjustment amount of the direction control mechanism 107 based on the detected deviation. The direction control unit 110 controls a beam irradiation direction by outputting a control command to the direction control mechanism 107 based on the calculated adjustment amount.

The data processing unit 201 performs framing and signal processing on data to be transmitted to the fixed station 150. The optical signal transmission unit 202 converts an output signal of the data processing unit 201 into an optical signal. The optical signal reception unit 203 receives an optical signal transmitted from the fixed station 150 and converts the received optical signal into an electrical signal. The data acquisition unit 204 performs signal processing such as demodulation and decoding and deframing on the output of the optical signal reception unit 203. The transmission/reception coupling unit 205 outputs the optical signal output from the optical signal transmission unit 202 and the optical signal input via the direction control mechanism 207 in a desired direction. For example, the transmission/reception coupling unit 205 outputs the optical signal output from the optical signal transmission unit 202 to the direction control mechanism 207. For example, the transmission/reception coupling unit 205 outputs the optical signal input via the direction control mechanism 207 to the distribution unit 206.

The distribution unit 206 distributes and outputs the optical signal output from the transmission/reception coupling unit 205 to the optical signal reception unit 203 and the optical signal center deviation detection unit 208. The direction control mechanism 207 adjusts a direction for performing free space optical communication with the fixed station 150. For example, the direction control mechanism 207 adjusts the direction of a laser so that the directivity is directed in a direction in which an optical signal can be transmitted and received to and from the fixed station 150. The optical signal center deviation detection unit 208 detects a deviation between a reception surface and an optical signal based on the optical signal distributed by the distribution unit 206.

The direction adjustment amount calculation unit 209 calculates an adjustment amount of the direction control mechanism 207 based on the detected deviation. The direction control unit 210 controls a beam irradiation direction by outputting a control command to the direction control mechanism 207 based on the calculated adjustment amount. The movement control information reception unit 211 receives movement control information output from the mobile object control terminal 350. The mobile object control unit 212 controls the mobile object 250 based on the movement control information acquired by the movement control information reception unit 211. For example, the mobile object control unit 212 moves the mobile object 250 in a designated direction based on the movement control information.

### CITATION LIST

### Non Patent Literature

[NPL 1] Kosuke MORI, “Fast Handover Mechanism for High Data Rate Ground-to-Train Free-Space Optical Communication Transceiver for Internet Streaming Applications”, IEICE TRANS.

### SUMMARY OF INVENTION

### Technical Problem

In the related art, the mobile object 250 moves, a deviation of a beam caused by the movement of the mobile object 250 is detected by an optical signal received by the fixed station 150, and a beam irradiation direction is controlled. FIGS. 9 and 10 show images of control of a beam irradiation direction. FIGS. 9 and 10 show images of control of an irradiation direction of a beam B at every control cycle At of the direction control mechanism 107. FIG. 9 shows a control image when the mobile object 250 is an object whose moving direction cannot be predicted, and FIG. 10 shows a control image when the mobile object 250 is an object whose moving direction can be predicted. The object whose moving direction cannot be predicted is, for example, an object of remote control such as a drone whose moving direction is not determined. The object whose moving direction can be predicted is an object such as a train or a satellite.

In FIG. 9, at time t=0, the mobile object 250 is located within the range of the beam B emitted by the fixed station 150, and communication based on free space optical communication can be performed. It is assumed that the mobile object 250 moves rightward from the position at time t=0. In this case, at time t=Δt, the mobile object 250 has moved to a position slightly deviating from the range of the beam B emitted by the fixed station 150. In the fixed station 150, a deviation is detected by receiving the beam B emitted from the mobile object 250, and the irradiation direction of the beam B is controlled after the deviation is detected. However, when the moving speed of the mobile object 250 is high, the mobile object 250 has moved further in the right direction at time t=2Δt, and thus an operation of tracking to the mobile object 250 may not be in time. As a result, prestige is unintentionally interrupted.

On the other hand, when the mobile object 250 is a train as in the related art, a moving direction and a speed are determined in advance. For this reason, movement information (for example, a moving direction and a speed) of the mobile object 250 can be used for controlling the irradiation direction of the beam B of the fixed station 150. Thereby, as shown in FIG. 10, even when the mobile object 250 has moved rightward at the time t=Δt and 2Δt, communication can be continued by controlling the irradiation direction of the beam B of the fixed station 150 in advance to be in a direction in which the mobile object 250 is located at the time t=Δt and 2Δt.

However, in the mobile object 250 such as a drone, the moving direction and speed are not determined in advance in contrast with a train, a satellite or the like. Further, when the moving direction or speed changes, there is a transition time while the original moving direction or speed transitions to a designated moving direction or speed, but information for controlling the mobile object 250 does not include how the moving direction or speed changes during the transition time. For this reason, in the related art, in a mobile object in which a moving path is not determined in advance, it is difficult to use movement information for the control of the irradiation direction of the beam B.

In view of the above circumstances, an object of the present invention is to provide a technique capable of using movement information for the control of an irradiation direction of a beam in a mobile object in which a moving path is not determined in advance.

### Solution to Problem

An aspect of the present invention is a fixed station that performs free space optical communication with a mobile object in which a moving path is not determined in advance, the fixed station including a movement control information reception unit that receives movement control information, which is information for moving the mobile object to a designated position, the movement control information being transmitted from a mobile object control terminal that controls an operation of the mobile object, an adjustment amount calculation unit that calculates an adjustment amount for controlling an irradiation direction of a beam at every control cycle by predicting a speed change of the mobile object based on the movement control information received by the movement control information reception unit, and a direction control unit that controls the irradiation direction of the beam at every control cycle based on the adjustment amount at every control cycle which is calculated by the adjustment amount calculation unit.

An aspect of the present invention is a mobile object in which a moving path for performing free space optical communication with a fixed station is not determined in advance, the mobile object including a movement control information reception unit that receives movement control information, which is information for moving the mobile object to a designated position, the movement control information being transmitted from a mobile object control terminal that controls an operation of the mobile object, a mobile object control unit that controls an operation of the mobile object based on the movement control information received by the movement control information reception unit, an adjustment amount calculation unit that calculates an adjustment amount for controlling an irradiation direction of a beam at every control cycle by predicting a speed change of the mobile object based on the movement control information received by the movement control information reception unit, and a direction control unit that controls the irradiation direction of the beam at every control cycle based on the adjustment amount at every control cycle which is calculated by the adjustment amount calculation unit.

An aspect of the present invention is a communication system including a mobile object, a fixed station that performs free space optical communication with the mobile object, and a mobile object control terminal that controls an operation of the mobile object, in which the fixed station includes a first movement control information reception unit that receives movement control information which is information for moving the mobile object to a designated position, the movement control information being transmitted from the mobile object control terminal, an adjustment amount calculation unit that calculates an adjustment amount for controlling an irradiation direction of a beam at every control cycle by predicting a speed change of the mobile object based on the movement control information received by the first movement control information reception unit, and a direction control unit that controls the irradiation direction of the beam at every control cycle based on the adjustment amount at every control cycle which is calculated by the adjustment amount calculation unit, and the mobile object includes a second movement control information reception unit that receives the movement control information transmitted from the mobile object control terminal, and a mobile object control unit that controls an operation based on the movement control information received by the second movement control information reception unit.

An aspect of the present invention is a beam direction control method including receiving movement control information which is information for moving a mobile object to a designated position, the movement control information being transmitted from a mobile object control terminal that controls an operation of the mobile object in which a moving path is not determined in advance, calculating an adjustment amount for controlling an irradiation direction of a beam at every control cycle by predicting a speed change of the mobile object based on the received movement control information, and controlling the irradiation direction of the beam at every control cycle based on the calculated adjustment amount at every control cycle.

### Advantageous Effects of Invention

According to the present invention, in a mobile object in which a moving path is not determined in advance, movement information can be used for the control of an irradiation direction of a beam.

### BRIEF DESCRIPTION OF DRAWINGS

FIG. 1 A diagram showing a configuration example of a communication system in an embodiment.

FIG. 2A A diagram showing an example of movement control information received by a movement control information reception unit in the embodiment.

FIG. 2B A diagram showing an example of movement control information received by a movement control information reception unit in the embodiment.

FIG. 3A A diagram showing an example of speed change information in the embodiment.

FIG. 3B A diagram showing an example of speed change information in the embodiment.

FIG. 4 is a diagram regarding changes in speed of a mobile object in the embodiment.

FIG. 5 A sequence diagram showing a flow of processing of the communication system according to the embodiment.

FIG. 6 A diagram showing an operation image when a method of controlling a beam irradiation direction in the embodiment is used.

FIG. 7 A diagram showing speed change information when the method of controlling a beam irradiation direction in the embodiment is used.

FIG. 8 A diagram showing a configuration example of a communication system of the related art.

FIG. 9 A diagram showing a control image when a mobile object is an object whose moving direction cannot be predicted.

FIG. 10 A diagram showing a control image when a mobile object is an object whose moving direction can be predicted.

### DESCRIPTION OF EMBODIMENTS

Hereinafter, an embodiment of the present invention will be described with reference to the accompanying drawings.

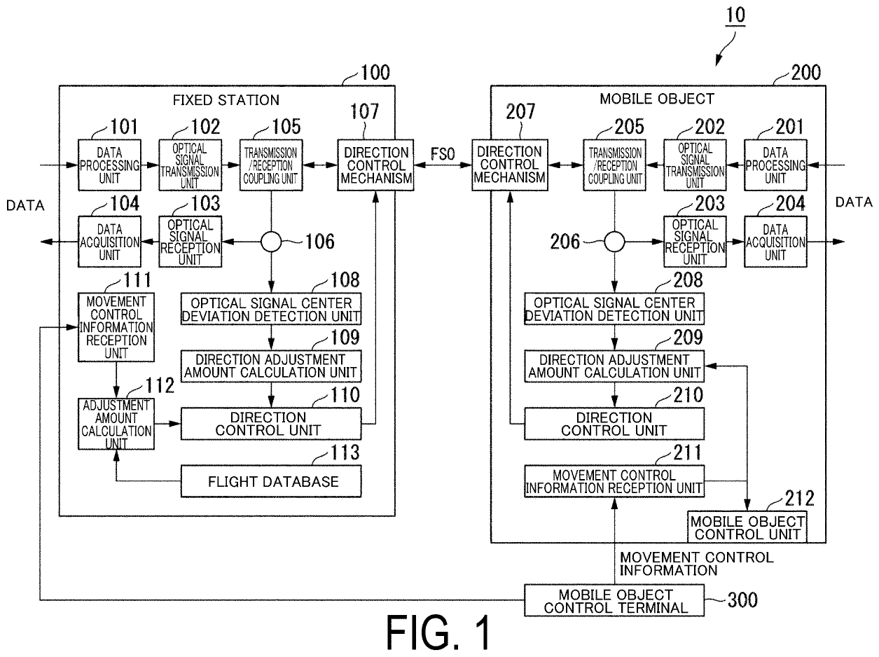

FIG. 1 is a diagram showing a configuration example of a communication system 10 according to an embodiment. The communication system 10 includes a fixed station 100, a mobile object 200, and a mobile object control terminal 300. FIG. 1 shows a case where each of the number of fixed stations 100, the number of mobile objects 200 and the number of mobile object control terminals 300 is one, but the number of fixed stations 100, the number of mobile objects 200 and the number of mobile object control terminals 300 may be two or more. Communication between the fixed station 100 and the mobile object 200 is performed by free space optical communication. Communication between the mobile object 200 and the mobile object control terminal 300, and communication between the fixed station 100 and the mobile object control terminal 300 are communication using visible light including radio waves, infrared light, or the like.

The fixed station 100 performs free space optical communication with the mobile object 200 by controlling an irradiation direction of a beam B. The fixed station 100 transmits the beam B to the mobile object 200 or receives the beam B transmitted from the mobile object 200. Further, the fixed station 100 receives movement control information transmitted from the mobile object control terminal 300. The movement control information is information for moving the mobile object 200 to a designated position, and includes at least one or more pieces of information of, for example, an orientation (direction) or a size (speed). The fixed station 100 is, for example, a communication device whose installation position is fixed in advance.

The mobile object 200 performs free space optical communication with the fixed station 100 by controlling the irradiation direction of the beam B. The mobile object 200 is a remotely controlled unmanned flying body such as a drone. The mobile object 200 may be any object such as a train or a satellite having no predetermined moving path, the moving direction of which can be freely changed by a user's operation. The mobile object 200 transmits the beam B to the fixed station 100 or receives the beam B transmitted from the fixed station 100. Further, the mobile object 200 moves in a direction designated by the movement control information transmitted from the mobile object control terminal 300. When the movement control information includes information on a speed, the mobile object 200 moves at a speed designated by the movement control information.

The mobile object control terminal 300 controls the operation of the mobile object 200. The mobile object control terminal 300 transmits movement control information including information for giving an instruction for a moving direction and a speed of the mobile object 200 to the fixed station 100 and the mobile object 200. The mobile object control terminal 300 is operated by the user.

Next, specific configurations of the fixed station 100 and the mobile object 200 will be described. First, a functional configuration of the fixed station 100 will be described. The fixed station 100 includes a data processing unit 101, an optical signal transmission unit 102, an optical signal reception unit 103, a data acquisition unit 104, a transmission/reception coupling unit 105, a distribution unit 106, a direction control mechanism 107, an optical signal center deviation detection unit 108, a direction adjustment amount calculation unit 109, a direction control unit 110, a movement control information reception unit 111, an adjustment amount calculation unit 112, and a flight database 113.

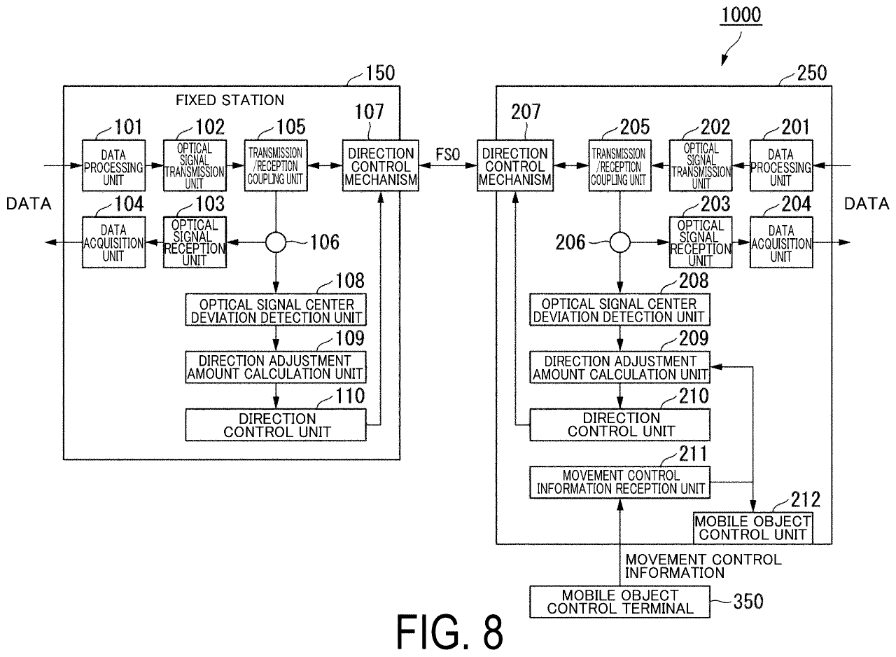

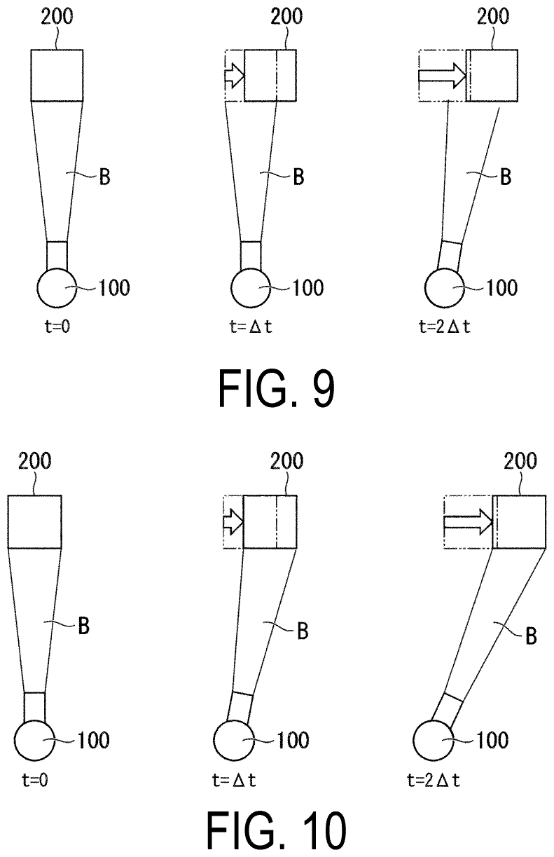

The data processing unit 101, the optical signal transmission unit 102, the optical signal reception unit 103, the data acquisition unit 104, the transmission/reception coupling unit 105, the distribution unit 106, the direction control mechanism 107, the optical signal center deviation detection unit 108, the direction adjustment amount calculation unit 109 and the direction control unit 110, which are provided in the fixed station 100, perform the same processing as those of the functional units having the same names of the fixed station 150 shown in FIG. 8. Hereinafter, differences from the fixed station 150 will be mainly described.

The movement control information reception unit 111 receives movement control information transmitted from a mobile object control terminal 300. When the mobile object control terminal 300 controls the mobile object 200 by radio communication, the movement control information reception unit 111 of the fixed station 100 has the same configuration as the movement control information reception unit 211 of the mobile object 200 capable of receiving the radio communication. The movement control information reception unit 111 is one aspect of a first movement control information reception unit.

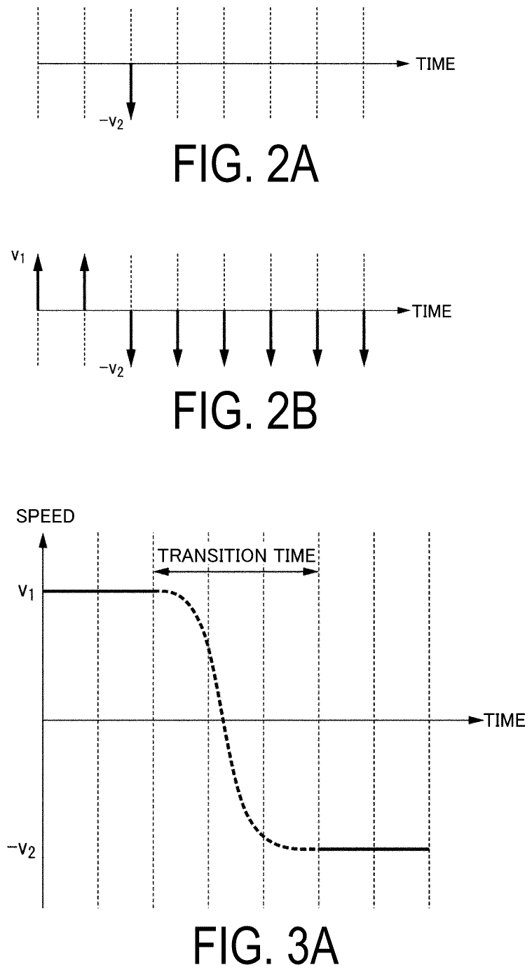

FIGS. 2A and 2B are diagrams showing an example of movement control information received by the movement control information reception unit in the embodiment. In FIG. 2A, it is assumed that the mobile object 200 continues to move at a speed −V2 in an indicated direction after the mobile object control terminal 300 once transmits the movement control information (for example, a speed −V2), and the movement control information is transmitted again at a timing when the speed of the mobile object 200 is changed.

On the other hand, in FIG. 2B, it is assumed that the mobile object control terminal 300 continues to transmit the movement control information and the mobile object 200 moves in response to each instruction of the movement control information.

Returning to FIG. 1, description will continue. The adjustment amount calculation unit 112 calculates an adjustment amount based on the movement control information received by the movement control information reception unit 111 and past flight data of the mobile object 200 stored in the flight database 113. The adjustment amount calculated by the adjustment amount calculation unit 112 is an adjustment amount for controlling an irradiation direction of a beam B. For example, the adjustment amount includes a value indicating the degree of change in the angle of the irradiation direction of the beam B.

The flight database 113 is a database in which information (hereinafter referred to as “speed change information”) representing a transition of a speed change within a transition time is registered for each of a moving speed before the change and a moving speed after the change. For example, in the flight database 113, information indicating how the speed changes until the speed changes from a first moving speed to a second moving speed within the transition time is registered as speed change information for each of the moving speed before the change and the moving speed after the change.

FIGS. 3A and 3B are diagrams showing an example of speed change information in the embodiment. Even in the same mobile object 200, it is considered that a transition time and a speed change during the transition time vary depending on two of a moving speed before the change and a moving speed after the change. The moving speed before the change can be estimated from the past moving control information or an adjustment amount within the current control cycle.

The speed change within the transition time from the moving speed before the change (for example, a moving speed V1) to the moving speed after the change (for example, a moving speed −V2) is considered to be different for each mobile object 200 as shown in FIG. 3A and FIG. 3B. As a method of obtaining a speed change within a transition time according to a moving speed before the change and a moving speed after the change, it is conceivable to acquire past flight data of the mobile object 200 in advance. Speed change information within the transition time is acquired for each combination of the moving speed before the change and the moving speed after the change from the past flight data, and the acquired speed change information within the transition time is registered in the flight database 113. By repeating this processing, the speed change information within the transition time for each combination of the moving speed before the change and the moving speed after the change is registered in the flight database 113.

When movement control information is acquired during communication between the fixed station 100 and the mobile object 200, the adjustment amount calculation unit 112 acquires speed change information within a transition time corresponding to a combination of the current moving speed of the mobile object 200 and a moving speed indicated by the movement control information with reference to the flight database 113. Here, the current moving speed of the mobile object 200 is the moving speed before the change, and the moving speed indicated by the moving control information is the moving speed after the change. The adjustment amount calculation unit 112 calculates an adjustment amount at every control cycle At with reference to the acquired speed change information.

When the number of pieces of speed change information registered in the flight database 113 is small, it is also assumed that there is no speed change information within the transition time corresponding to the combination of the current moving speed of the mobile object 200 and the moving speed indicated by the movement control information. Consequently, when the speed change information within the transition time corresponding to the combination of the current moving speed of the mobile object 200 and the moving speed indicated by the movement control information is not registered in the flight database 113, the adjustment amount calculation unit 112 may acquire speed change information within a transition time corresponding to a combination close to the combination. In this manner, the adjustment amount calculation unit 112 calculates an adjustment amount for controlling the irradiation direction of the beam B at every control cycle by predicting the speed change of the mobile object 200 based on the movement control information.

The direction control unit 110 controls the irradiation direction of the beam B by outputting a control command to the direction control mechanism 107 based on the adjustment amount calculated by the direction adjustment amount calculation unit 109 or the adjustment amount calculation unit 112. Specifically, when the movement control information transmitted from the mobile object control terminal 300 is received, the direction control unit 110 controls the irradiation direction of the beam B by outputting a control command to the direction control mechanism 107 based on the adjustment amount calculated by the adjustment amount calculation unit 112. When the movement control information is not received, the direction control unit 110 controls the irradiation direction of the beam B by outputting a control command to the direction control mechanism 107 based on the adjustment amount calculated by the direction adjustment amount calculation unit 109.

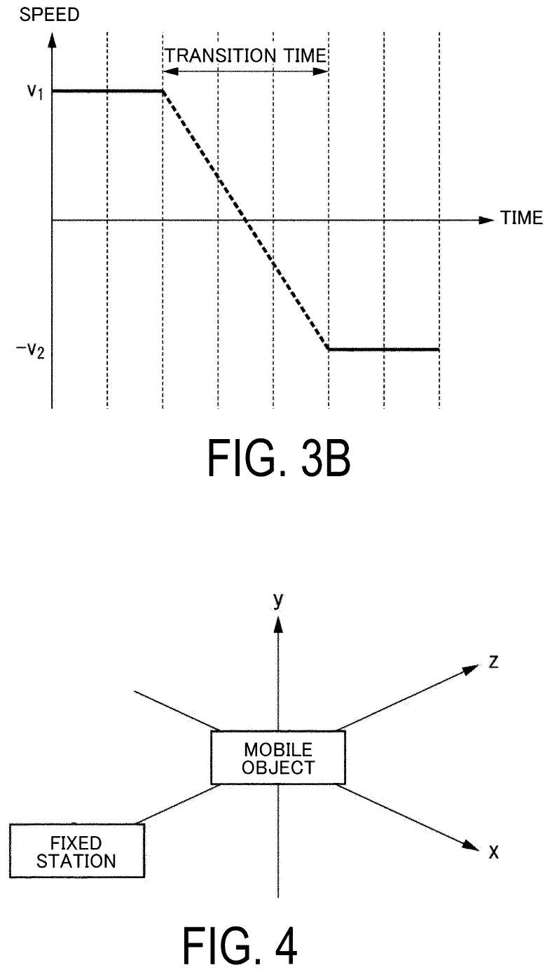

FIG. 4 is a diagram regarding changes in the speed of the mobile object 200 in the embodiment. As shown in FIG. 4, the moving direction of the beam B emitted from the fixed station 100 is assumed to be a z-direction, and a horizontal plane with respect to the z-direction is assumed to be an xy plane. Since it is not necessary for the fixed station 100 to perform direction control for the movement of the mobile object 200 in the z-direction, the movement in the z-direction is not considered thereafter. The x-direction and a y-direction can be considered independently. That is, the change in the direction of the mobile object 200 is replaced by a combination of changes in the speed in the x-direction or the y-direction. For this reason, in the following description, a speed change in the x-direction is considered.

Next, specific operations of the adjustment amount calculation unit 112 will be described. The adjustment amount calculation unit 112 calculates an adjustment amount of an irradiation direction of the beam B at every control cycle Δt with respect to a control cycle Δt of the direction control mechanism 107. As described above, when assuming only the movement in the x-direction, the adjustment amount calculation unit 112 calculates an angle to be adjusted as an adjustment amount by tan (a/z), where a is a movement amount of the mobile object 200 during the control cycle Δt of the direction control mechanism 107 and z is a communication distance between the fixed station 100 and the mobile object 200.

The movement amount a can be obtained by integrating a speed Vₜ (a=∫Vₜdt). Here, the range of integration is a period from the time when the adjustment amount is calculated (hereinafter referred to as “calculation time”) to the calculation time +Δt. The speed Vₜ represents a speed at time t in the range of integration. When the amount of change in speed in units of the control cycle Δt is small, it is also considered that the movement amount a is simply obtained by a=Δt×v. Here, the speed v may be either a speed at the present point in time or a speed assumed after the control cycle Δt.

When the movement control information includes information on a moving speed, the optical signal center deviation detection unit 108 may be configured to predict a movement amount of the mobile object 200, that is, a deviation amount of an optical signal, based on the information on the moving speed.

Next, a functional configuration of the mobile object 200 will be described. The mobile object 200 includes a data processing unit 201, an optical signal transmission unit 202, an optical signal reception unit 203, a data acquisition unit 204, a transmission/reception coupling unit 205, a distribution unit 206, a direction control mechanism 207, an optical signal center deviation detection unit 208, a direction adjustment amount calculation unit 209, a direction control unit 210, a movement control information reception unit 211, and a mobile object control unit 212. The functional units included in the mobile object 200 perform the same processing as those of the functional units included in the mobile object 250 shown in FIG. 8. Here, the movement control information reception unit 211 is one aspect of a second movement control information reception unit.

The mobile object control unit 212 may acquire information on a moving speed of the mobile object 200 in real time and transmit it to the direction adjustment amount calculation unit 209. When the movement control information includes the information on the moving speed, the optical signal center deviation detection unit 208 may be configured to predict a movement amount of the mobile object 200, that is, a deviation amount of an optical signal, based on the information on the moving speed.

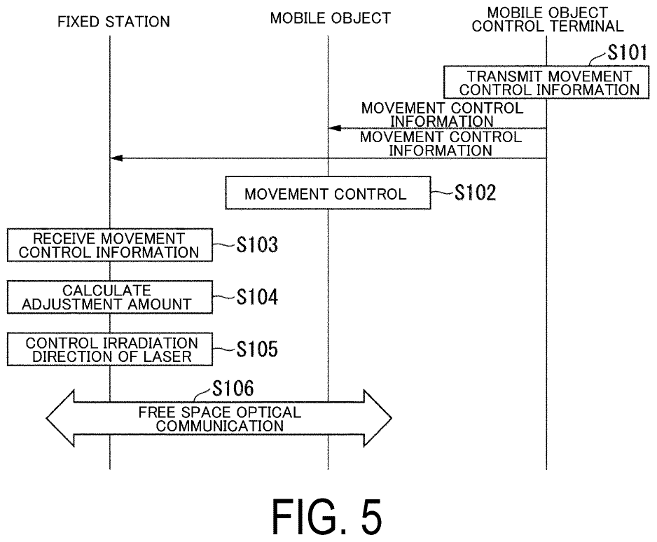

FIG. 5 is a sequence diagram showing a flow of processing of the communication system 10 in the embodiment.

The mobile object control terminal 300 transmits movement control information according to an instruction input from a user to the fixed station 100 and the mobile object 200 (step S101). The movement control information reception unit 211 of the mobile object 200 receives the movement control information transmitted from the mobile object control terminal 300. The movement control information reception unit 211 outputs the received movement control information to the mobile object control unit 212. The mobile object control unit 212 controls an operation of the mobile object 200 based on the movement control information output from the movement control information reception unit 211 (step S102).

Specifically, when a moving target direction is designated by the movement control information, the mobile object control unit 212 controls the operation of the mobile object 200 so that the mobile object 200 moves in the direction designated by the movement control information. When a moving speed is designated by the movement control information, the mobile object control unit 212 controls the operation of the mobile object 200 so that the mobile object 200 moves at the speed designated by the movement control information. When a moving target direction and a moving speed are designated by the movement control information, the mobile object control unit 212 controls the operation of the mobile object 200 so that the mobile object 200 moves at the designated speed in the direction designated by the movement control information. Thereby, the mobile object 200 moves.

The movement control information reception unit 111 of the fixed station 100 receives the movement control information transmitted from the mobile object control terminal 300 (step S103). The movement control information reception unit 111 outputs the received movement control information to the adjustment amount calculation unit 112. The adjustment amount calculation unit 112 calculates an adjustment amount based on the movement control information output from the movement control information reception unit 111 and the flight database 113 (step S104).

Specifically, the adjustment amount calculation unit 112 acquires speed change information corresponding to a combination of the moving speed designated by the movement control information and the current moving speed of the mobile object 200 with reference to the flight database 113. Next, the adjustment amount calculation unit 112 calculates a movement amount a at every At in the acquired speed change information. For example, the adjustment amount calculation unit 112 calculates, at every At, the movement amount a in the speed change information from the current moving speed of the mobile object 200 to the moving speed designated by the movement control information, such as a movement amount a1 between Δt and 2Δt and a movement amount a2 between 2Δt and 3Δt.

The adjustment amount calculation unit 112 calculates an adjustment amount based on the calculated movement amount a and a communication distance z between the fixed station 100 and the mobile object 200. For example, the adjustment amount calculation unit 112 calculates an adjustment amount based on the movement amount al and the communication distance z1. Similarly, the adjustment amount calculation unit 112 calculates an adjustment amount based on the movement amount a2 and a communication distance z2. In this manner, the movement amount a and the communication distance z change at every Δt. The adjustment amount calculation unit 112 calculates an adjustment amount at every Δt by repeating this processing.

When only a direction is designated by the movement control information, the mobile object 200 moves at the same moving speed as the current moving speed. In this case, the speed of the mobile object 200 does not change. When the speed of the mobile object 200 does not change, the movement amount a at every Δt is the same. That is, the adjustment amount calculation unit 112 calculates a movement amount a at every Δt based on the current speed of the mobile object 200. The adjustment amount calculation unit 112 calculates an adjustment amount based on the calculated movement amount a and the communication distance z between the fixed station 100 and the mobile object 200.

The adjustment amount calculation unit 112 outputs information on the calculated adjustment amount to the direction control unit 110. The direction control unit 110 controls the irradiation direction of the beam B by outputting a control command to the direction control mechanism 107 based on the information on the adjustment amount output from the adjustment amount calculation unit 112 (step S105). The direction control unit 110 controls the irradiation direction of the beam B by outputting the information on the adjustment amount as a control command to the direction control mechanism 107 at every control cycle At within a transition time. Thereby, free space optical communication is performed between the fixed station 100 and the mobile object 200 (step S106).

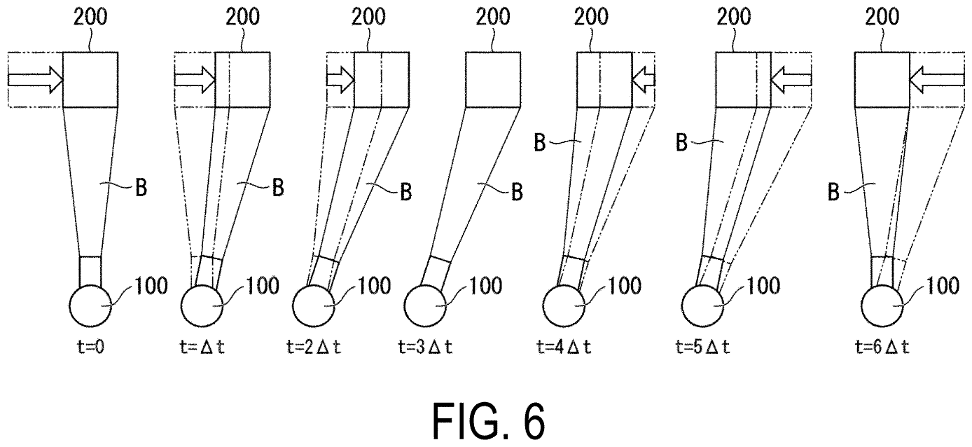

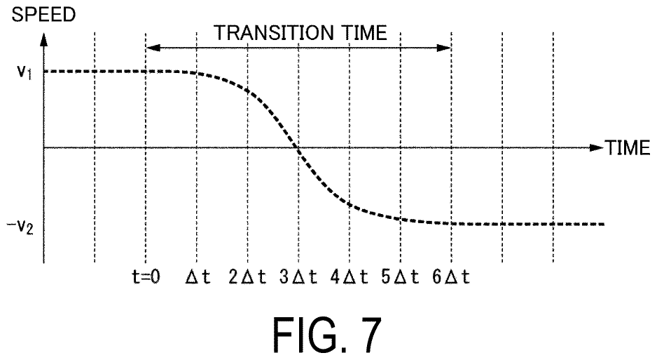

FIG. 6 is a diagram showing an operation image when a method of controlling the irradiation direction of the beam B in the embodiment is used. FIG. 7 is a diagram showing speed change information when a method of controlling the irradiation direction of the beam B in the embodiment is used. In FIG. 6, at time t=0, the mobile object 200 is located within the range of the beam B emitted by the fixed station 100, and communication based on free space optical communication can be performed. It is assumed that the mobile object 200 moves rightward from the position of time t=0 at time t=Δt in accordance with the movement control information transmitted from the mobile object control terminal 300. In this case, the fixed station 100 also receives the movement control information transmitted from the mobile object control terminal 300. The fixed station 100 calculates an adjustment amount based on the received movement control information, and controls the irradiation direction of the beam B based on the adjustment amount, whereby the beam B can be emitted in a direction in which the mobile object 200 is located at time t=Δt.

Even when the time t has elapsed like 2Δt, 3Δt, 4Δt, 5Δt, and 6Δt, the fixed station 100 can follow the mobile object 200 to control the irradiation direction of the beam B at every control cycle Δt based on the movement control information.

According to the communication system 10 configured as described above, in a mobile object in which a moving path is not determined in advance, movement information can be used for the control of the irradiation direction of the beam B. Specifically, the fixed station 100 includes the movement control information reception unit 111 that receives movement control information transmitted from the mobile object control terminal 300, the adjustment amount calculation unit 112 that calculates an adjustment amount for controlling an irradiation direction of the beam B at every control cycle by predicting a speed change of the mobile object 200 based on the movement control information which is received by the movement control information reception unit 111, and the direction control unit 110 that controls the irradiation direction of the beam B at every control cycle based on the adjustment amount at every control cycle which is calculated by the adjustment amount calculation unit 112. The mobile object 200 includes the movement control information reception unit 211 that receives movement control information transmitted from the mobile object control terminal 300, and the mobile object control unit 212 that controls an operation based on the movement control information received by the movement control information reception unit 211. Thereby, even when the moving speed of the mobile object 200 changes in real time in response to an instruction given from the mobile object control terminal 300, the change in the moving speed of the mobile object 200 can also be grasped even in the fixed station 100. Thus, the fixed station 100 can control the irradiation direction of the beam B based on information on the grasped change in the moving speed of the mobile object 200. For this reason, in a mobile object in which a moving path is not determined in advance, the movement information can be used for the control of the irradiation direction of the beam B.

The optical signal center deviation detection units 108 and 208 transmit information (deviation information) obtained after the mobile object 200 moves to the direction adjustment amount calculation units 109 and 209, but when the movement control information includes information on a moving speed, a future movement amount of the mobile object 200, that is, a deviation amount of an optical signal can be predicted, and thus it is possible to expect more rapid control of the irradiation direction of the beam B.

### Modification Example 1

In the above-described embodiment, description has been given of a configuration in which speed change information for each combination of a moving speed before a change and a moving speed after the change is previously registered in the flight database 113. On the other hand, a configuration may be adopted in which, when the mobile object 200 moves with a speed change, speed information of the mobile object 200 is recorded, and speed change information within a transition time registered in the flight database 113 is updated and added. Alternatively, the fixed station 100 may estimate a transition time and a speed change by utilizing machine learning.

### Modification Example 2

It is considered that the mobile object 200 is configured such that the mobile object control unit 212 acquires information on a moving speed of the mobile object 200 in real time and transmits the information to the direction adjustment amount calculation unit 209 to perform control. Instead of performing the operation, the mobile object 200 may be configured such that an adjustment amount calculation unit having the same function as the adjustment amount calculation unit 112 provided in the fixed station 100 is provided between the movement control information reception unit 211 and the direction control unit 210 and calculates an adjustment amount by the same method as for the adjustment amount calculation unit 112. In such a configuration, the mobile object 200 further includes the flight database 113. The direction control unit 210 provided in the mobile object 200 controls the irradiation direction of the beam B by outputting a control command to the direction control mechanism 207 based on the adjustment amount calculated by the direction adjustment amount calculation unit 209 or the adjustment amount calculation unit. Specifically, when movement control information transmitted from the mobile object control terminal 300 is received, the direction control unit 210 controls the irradiation direction of the beam B by outputting a control command to the direction control mechanism 207 based on the adjustment amount calculated by the arrangement amount calculation unit. When the movement control information is not received, the direction control unit 210 controls the irradiation direction of the beam B by outputting a control command to the direction control mechanism 207 based on the adjustment amount calculated by the direction adjustment amount calculation unit 209.

With such a configuration, the irradiation direction of the beam B can be automatically controlled even in the mobile object 200.

Some of the functional units of the fixed station 100 and the mobile object 200 in the above-described embodiment may be realized by a computer. In such a case, a program for realizing this function may be recorded on a computer-readable recording medium, and the program recorded on the recording medium may be read and executed by the computer system. Further, the “computer system” recited herein includes an operating system (OS) and hardware such as peripheral devices.

In addition, the “computer-readable recording medium” includes a portable medium such as a flexible disk, magneto-optical disk, a read only memory (ROM) and a CD-ROM, and various storage apparatuses such as a hard disk built into a computer system. Further, the “computer-readable recording medium” may also include a recording medium that dynamically holds a program for a short period of time, such as a communication line when the program is transmitted over a network such as the Internet or a communication line such as a telephone line or a recording medium that holds a program for a certain period of time, such as a volatile memory inside a computer system serving as a server or a client in such a case. The above-mentioned program may be a program implementing some of the above-described functions, may be a program implemented in a combination of the above-described functions and a program already recorded in a computer system, or may be implemented with a programmable logic device such as a field programmable gate array (FPGA).

Although the embodiment of the present invention has been described in detail with reference to the drawings, a specific configuration is not limited to this embodiment and design within the scope of the gist of the present invention, and the like are included.

### Industrial Applicability

The present invention is applicable to an optical space communication system.

### REFERENCE SIGNS LIST

10 Communication system
100 Fixed stations
101, 201 Data processing unit
102, 202 Optical signal transmission unit
103, 203 Optical signal reception unit
104, 204 Data acquisition unit
105, 205 Transmission/reception coupling unit
106, 206 Distribution unit
107, 207 Direction control mechanism
108, 208 Optical signal center deviation detection unit
109, 209 Direction adjustment amount calculation unit
110, 210Direction control unit
111, 211 Movement control information reception unit
112 Adjustment amount calculation unit
113 Flight database
212 Mobile object control unit

1. A fixed station that performs free space optical communication with a mobile object in which a moving path is not determined in advance, the fixed station comprising:
a movement control information receiver configured to receive movement control information, which is information for moving the mobile object to a designated position, the movement control information being transmitted from a mobile object control terminal that controls an operation of the mobile object;
an adjustment amount calculator configured to calculate an adjustment amount for controlling an irradiation direction of a beam at every control cycle by predicting a speed change of the mobile object based on the movement control information received by the movement control information receiver; and
a direction controller configured to control the irradiation direction of the beam at every control cycle based on the adjustment amount at every control cycle which is calculated by the adjustment amount calculator.

2. The fixed station according to claim 1, wherein
the movement control information includes information on at least one or more of a direction and a speed, and
the adjustment amount calculator calculates, when the movement control information includes information on the speed, a movement amount of the mobile object at every control cycle by using speed change information indicating a transition of a speed change within a transition time from the speed of the mobile object before the change to the speed included in the movement control information, and calculates the adjustment amount at every control cycle based on the calculated movement amount of the mobile object at every control cycle and a communication distance.

3. The fixed station according to claim 1, wherein
the movement control information includes information on at least one or more of a direction and a speed, and
the adjustment amount calculator calculates, when the movement control information includes information on the direction, a movement amount of the mobile object at every control cycle based on the speed of the mobile object, and calculates the adjustment amount at every control cycle based on the calculated movement amount of the mobile object at every control cycle and a communication distance.

4. A mobile object in which a moving path for performing free space optical communication with a fixed station is not determined in advance, the mobile object comprising:
a movement control information receiver configured to receive movement control information, which is information for moving the mobile object to a designated position, the movement control information being transmitted from a mobile object control terminal that controls an operation of the mobile object;
a mobile object controller configured to control an operation of the mobile object based on the movement control information received by the movement control information receiver;
an adjustment amount calculator that calculates an adjustment amount for controlling an irradiation direction of a beam at every control cycle by predicting a speed change of the mobile object based on the movement control information received by the movement control information receiver; and
a direction controller unit configured to control the irradiation direction of the beam at every control cycle based on the adjustment amount at every control cycle which is calculated by the adjustment amount calculator.
5. The mobile object according to claim 4, wherein
the movement control information includes information on at least one of a direction and a speed,
the adjustment amount calculator calculates, when the movement control information includes information on the speed, a movement amount of the mobile object at every control cycle by using speed change information indicating a transition of a speed change within a transition time from the speed of the mobile object before the change to the speed included in the movement control information, and calculates the adjustment amount at every control cycle based on the calculated movement amount of the mobile object at every control cycle and a communication distance.

6. The mobile object according to claim 4, wherein
the movement control information includes information on at least one or more of a direction and a speed, and
the adjustment amount calculator calculates, when the movement control information includes information on the direction, a movement amount of the mobile object at every control cycle based on the speed of the mobile object, and calculates the adjustment amount at every control cycle based on the calculated movement amount of the mobile object at every control cycle and a communication distance.

7. (canceled)

8. A beam direction control method comprising:
receiving movement control information which is information for moving a mobile object to a designated position, the movement control information being transmitted from a mobile object control terminal that controls an operation of the mobile object in which a moving path is not determined in advance;
calculating an adjustment amount for controlling an irradiation direction of a beam at every control cycle by predicting a speed change of the mobile object based on the received movement control information; and
controlling the irradiation direction of the beam at every control cycle based on the calculated adjustment amount at every control cycle.
